(19) United States
(12) Patent Application Publication
(10) Pub. No.: US 2012/0312559 A1
(43) Pub. Date: Dec. 13, 2012

(54) EXPANDABLE SEAL WITH CONFORMING RIBS

(76) Inventors: WILLIAM M. BAILEY, Humble, TX (US); Steven R. Hayter, Houston, TX (US)

(21) Appl. No.: 13/155,847

(22) Filed: Jun. 8, 2011

(51) Int. Cl. E21B 33/10; E21B 17/04; F16L 21/035

(52) U.S. Cl. 166/387; 277/607; 166/207

(57) ABSTRACT

Expandable seals have one or more conforming ribs to facilitate creation of a seal to a sealing surface disposed in the well. The conforming ribs comprise a core of material either capped, partially covered by, or entirely covered by a ring. The ring can be formed of a metal that is softer than the metallic core material of each rib. Suitable metals forming the rings include copper formed by metal spun methods. Disposed adjacent to the rings are one or more sealing elements. By moving the rings into the sealing surface during expansion of the expandable seals, the rings close the extrusion gaps between the internal surface of the casing and the expanded tubular member ribs. The rings better conform to the sealing surface of the casing, thereby facilitating the creation of the seal between this sealing surface and each of the sealing elements.

### BACKGROUND

1. Field of Invention

The present invention is directed to expandable seals for use in oil and gas wells and, in particular, expandable seals having conforming ribs comprising a metallic material that is softer or more malleable as compared to the metal forming the device carrying the seals to facilitate creation of the seal to a sealing surface disposed in the well.

2. Description of Art

Tubular members having a sealing element such as a packer have been used to seal the annulus of cased wells. In one operation, after the well is drilled into the earth formation an casing is run-in the open-hole formation, a tubular member having a packer is run-in the cased well. The packer is designed to divide the well by sealing against the inner wall of the casing, thereby isolating a lower portion of the annulus from an upper portion of the annulus.

In operation, after the tubular member is run into the desired location in the well, a cone or other device can be transported through the bore of the tubular member until it reaches a portion of the tubular member having a restricted inner diameter. Disposed on the outer wall surface of the tubular member at this location is a sealing element. As the cone, or expansion device, travels downward, this portion of the tubular member is expanded by the cone. The expansion of the tubular member causes the sealing element to contact the inner wall of the casing and separate the cased well into at least two isolated regions, one above the sealing element and one below the sealing element.

### SUMMARY OF INVENTION

Broadly, the invention is directed to expandable seals. In one embodiment, the expandable seal is disposed on a expandable tubular member such that as the tubular member is radially expanded, the seal contacts and seals against a sealing surface such as the inner wall surface of a cased wellbore. The expandable seals can have one or more conforming ribs disposed around an outer diameter, i.e., along an outer wall surface, of a tubular member. As used herein, the term “conforming” means that the rib, when pressed into the sealing surface of the casing, conforms to the shape of the sealing surface to which it is engaged. By conforming to the shape of the sealing surface, the a extrusion gap between sealing elements is closed off, thereby providing a better seal.

In one particular embodiment, one or more of the conforming ribs comprise a metallic core material capped, partially covered, or entirely covered by a metallic conforming material formed from a metal such as copper or other metal that is softer or more malleable than the metal forming the tubular member and, thus, softer than the core material of the rib. One or more sealing elements can be disposed either above, below, or both above and below the conforming rib to facilitate creation of the seal between the sealing surface and the tubular member.

### BRIEF DESCRIPTION OF DRAWINGS

FIG. 1 is a cross-sectional view of one embodiment of an expandable tubular member having a sealing device, FIG. 1 showing the tubular member in its run-in position prior to being expanded or moved into its set or sealing position.

FIG. 2 is a detailed cross-sectional view of the sealing device shown in FIG. 1.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

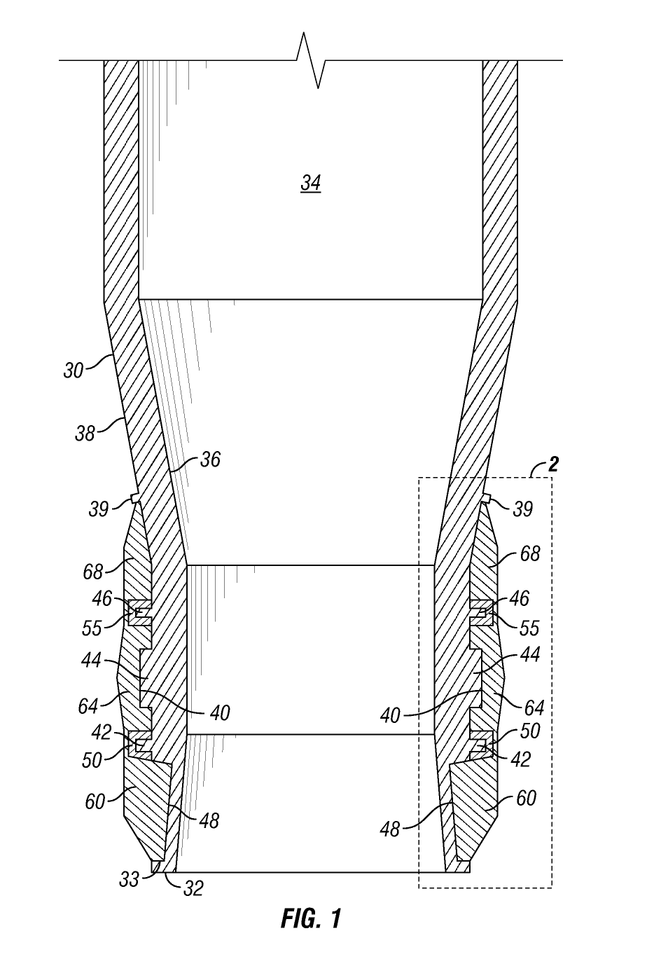

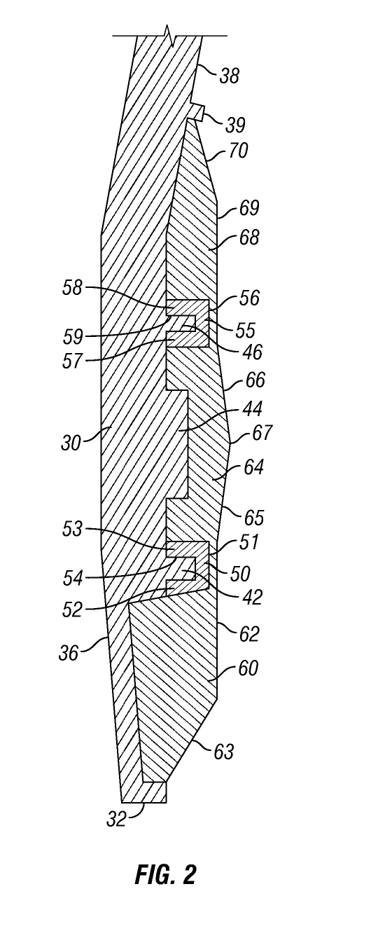

Referring now to FIGS. 1-2 in one specific embodiment, tubular member 30 comprises first end 32, bore 34 defined by inner wall surface 36, and outer wall surface 38. Outer wall surface 38 comprises profile 40. Profile 40 comprises first rib 42, second rib 44, third rib 46, and recess 48. Recess 48 is bound on one end by first end 32 which comprises shoulder 33. Disposed over first rib 42 and third rib 46 are rings 50, 55, respectively, comprising a conforming material. In one particular embodiment, the conforming materials of rings 50, 55 are metal spun wherein the metal is softer, i.e. more malleable, than the material forming tubular member 30, i.e., the core material. Because the conforming material is more malleable compared to the core material, when rings 50, 55 engage the sealing surface they conform to the shape of the sealing surface, thereby closing the extrusion gap between the sealing elements (discussed in greater detail below) and facilitating creation of the seal between the sealing elements and the sealing surface (not shown). One suitable metal for rings 50, 55 is copper where the metal forming tubular member 30 is stainless steel. Other suitable metals for rings 50, 55 include silver, gold, and alloys containing one or more of copper, silver, or gold. Other suitable metals forming tubular member 30 include low alloy steel or nickel alloy.

As shown in FIGS. 1-2, rings 50, 55, respectively, comprise outer diameter surfaces 51, 56, first sides 52, 57, and second sides 53, 58 to provide recesses 54, 59. Disposed within recesses 54, 59 are ribs 42, 46 so that ribs 42, 46 are completely covered by rings 50, 55. Although rings 50, 55 are shown as covering the entirety of first rib 42 and third rib 46, it is to be understood that rings 50, 55 are not required to be disposed over first rib 42 and third rib 46, provided the outer diameter surfaces of first rib 42 and third rib 46 are covered by rings 50, 55.

Disposed within recess 48 between shoulder 33 of first end 32 of tubular member 30 and first rib 42 (with ring 50), and bonded to outer wall surface 38, is first sealing element 60. First sealing element 60 may be bonded to outer wall surface 38 through any device or method known in the art. For example, first sealing element 60 may be bonded to outer wall surface 38 through chemical bonding. As best shown in FIG. 2, first sealing element 60 comprises outer diameter surface 62. Outer diameter surface 62 is slightly larger than outer diameter surface 51 of ring 50 so that, upon expansion of tubular member 30, ring 50 pierces sealing element 60 before engaging the inner wall surface of the wellbore casing. First sealing element 60 also comprises tapered surface to transition first sealing element 60 from outer diameter surface 62 to shoulder 33 of first end 32 of tubular member 30.

Disposed over second rib 44 between first rib 42 (with ring 50) and third rib 46 (with ring 52), and bonded to outer wall surface 38, is second sealing element 64. Second sealing element 64 may be bonded to outer wall surface 38 through any device or method known in the art. For example, second sealing element 64 may be bonded to outer wall surface 38 through chemical bonding. As shown best in FIG. 2, second sealing element 64 has tapered outer surfaces 65, 66 intersecting at apex 67. Tapered surfaces 65, 66 connect with first sealing element 60 and third sealing element 68 (discussed in greater detail below).

Disposed between third rib 46 (with ring 55) and flange 39 disposed on outer wall surface 38 of tubular member 30, and bonded to outer wall surface 38, is third sealing element 68. Third sealing element 68 may be bonded to outer wall surface 38 through any device or method known in the art. For example, third sealing element 68 may be bonded to outer wall surface 38 through chemical bonding. As best shown in FIG. 2, third sealing element 68 comprises outer diameter surface 69. Outer diameter surface 69 is slightly larger than outer diameter surface 56 of ring 55 so that, upon expansion of tubular member 30, ring 55 pierces sealing element 68 before engaging the inner wall surface of the wellbore casing. Third sealing element 68 also comprises tapered surface 70 to transition third sealing element 68 from outer diameter surface 69 toward outer wall surface 38 of tubular member 30 as tapered surface 70 approaches flange 39.

First sealing element 60, second sealing element 64, and third sealing element 68 may be formed out of any material known in the art. Suitable materials include, but are not limited to, elastomers, rubbers, polymers, or thermoplastics. In addition, none of first sealing element 60, second sealing element 64, or third sealing element 68 is required to have the shapes described with respect to the embodiments of FIGS. 1-2. To the contrary, first sealing element 60, second sealing element 64, and third sealing element 68 may have any shape desired or necessary to provide the requisite compression or deformation of first sealing element 60, second sealing element 64, and third sealing element 68 to form a seal with a sealing surface such as found on the inner wall of a wellbore.

In operation of the embodiment of FIGS. 1-2, after tubular member 30 is properly located within a wellbore (not shown), a cone (not shown) or other expanding device is run through bore 34 of tubular member 30. For example, as the cone travels downward in the Figures, i.e., downhole, tubular member 30 is forced radially outward from the longitudinal axis of tubular member 30. Alternatively, tubular member 30 can travel downward in the Figures to engage a stationary expansion device (not shown). The stationary expansion device causes first end 32 to radially expand allowing tubular member 30 to continue moving downward over the stationary expansion device. In either operation, tubular member 30 is forced radially outward causing the diameter of bore 34 to be radially expanded. As a result of the radial expansion of tubular member 30, rings 50, 55 pierce first sealing element 60 and third sealing element 68, respectively, and engage with the inner wall surface of the wellbore. Either simultaneously, or slightly before or after the engagement of rings 50, 55 with inner wall surface of the wellbore, outer diameter surface 62 of first sealing element 60, apex 67 of second sealing element 64, and outer diameter surface 69 of third sealing element 68 also engage with the inner wall surface of the wellbore. As the radial load is increased due to the passage of the cone through bore 34, rings 50, 55 are forced into the inner wall surface of the wellbore. In so doing, rings 50, 55 conform to the shape of the inner wall surface of the wellbore because rings 50, 55 are formed of a material that is more malleable than the material forming ribs 42, 46, as well as more malleable than the material forming the inner wall surface of the wellbore. As a result, rings 50, 55 close the extrusion gap between first and second sealing elements 60, 64 and the extrusion gap between second and third sealing elements 64, 68. In addition, first sealing element 60, second sealing element 64, and third sealing element 68 are forced into the inner wall surface of the casing to form a seal between the inner wall surface of the casing and sealing elements 60, 64, 68.

It is to be understood that the invention is not limited to the exact details of construction, operation, exact materials, or embodiments shown and described, as modifications and equivalents will be apparent to one skilled in the art. For example, the conforming material may completely encase or cover the ribs, or it may be disposed only on the outer surface of the ribs. Additionally, the conforming material is not required to be disposed on a rib, but instead can be disposed on the outer wall surface of the tubular member in other manners. For example, the conforming material may be an insert set into a groove cut into the outer wall surface of the tubular member. Moreover, one or more of first, second, and third sealing elements can be omitted. In addition, one or more of first, second, and third sealing elements can have shapes different than as described with respect to the embodiments of FIGS. 1-2. Further, the shape of the ribs can be modified from the shapes as shown in the embodiments of FIGS. 1-2. Further, although a cone is described as being used to expand the tubular member, it is to be understood that any device or method known to persons of ordinary skill in the art may be used to expand the tubular member. Accordingly, the invention is therefore to be limited only by the scope of the appended claims.

What is claimed is:

1. A sealing device for an expandable tubular, the sealing device comprising:
a tubular member having an outer wall surface and a bore defined by an inner wall surface; and
a seal disposed on the outer wall surface, the seal comprising a first rib, the first rib comprising a first metallic core material providing a first rib outer diameter surface and a first metallic conforming material disposed on at least a portion of the first rib outer diameter surface, the first metallic conforming material being more malleable compared to the first metallic core material.

2. The sealing device of claim 1, wherein the first metallic conforming material partially covers a first side of the first rib.

3. The sealing device of claim 2, wherein the first metallic conforming material completely covers the first rib.

4. The sealing device of claim 1, wherein the first metallic conforming material comprises copper.

5. The sealing device of claim 1, wherein the seal further comprises
a second rib, the second rib comprising a second metallic core material providing a second rib outer diameter surface and a second metallic conforming material disposed on at least a portion of the second rib outer diameter surface, the second metallic conforming material being more malleable compared to the second metallic core material.

6. The sealing device of claim 5, wherein the second metallic conforming material partially covers a first side of the second rib.

7. The sealing device of claim 6, wherein the second metallic conforming material completely covers the second rib.

8. The sealing device of claim 5, wherein the first metallic conforming material partially covers a first side of the first rib.

9. The sealing device of claim 8, wherein the first metallic conforming material completely covers the first rib.

10. The sealing device of claim 5, wherein the first metallic conforming material completely covers the first rib and the second metallic conforming material completely covers the second rib.

11. The sealing device of claim 5, wherein the first metallic conforming material and the second metallic conforming material comprise copper.

12. An expandable tubular for disposition within a wellbore, the expandable tubular comprising:
a radially expandable body having an outer wall surface, the body comprising a metallic core material;
a first metallic conforming material disposed on the outer wall surface, the first metallic conforming material engaging a sealing surface when the body is radially expanded, the first metallic conforming material being more malleable as compared to the metallic core material.

13. The expandable tubular of claim 12, wherein the first metallic conforming material is disposed on an outer diameter surface of a first rib, the first rib being disposed on the outer wall surface of the body.

14. The expandable tubular of claim 12, wherein the first metallic conforming material forms a first ring disposed around the outer wall surface of the body.

15. The expandable tubular of claim 14, wherein the first ring is disposed over a first rib, the first rib being disposed on the outer wall surface of the body.

16. The expandable tubular of claim 15, wherein the first ring completely covers the rib.

17. The expandable tubular of claim 12, further comprising a second metallic conforming material disposed on the outer wall surface.

18. The expandable tubular of claim 17, wherein the second metallic conforming material is disposed on an outer diameter surface of a second rib, the second rib being disposed on the outer wall surface of the body.

19. A method of sealing an annulus of a wellbore, the method comprising the steps of:
(a) running a tubular member into a wellbore defined by an inner wall surface, the tubular member having an outer wall surface and a sealing device disposed on the outer wall surface, the sealing device comprising a metallic core material and a metallic conforming material, the metallic conforming material being more malleable compared to the metallic core material, the metallic conforming material being disposed over a portion of the metallic core material on an outer wall surface of the sealing device;
(b) applying a radial load to expand the tubular member causing the metallic conforming material to engage the inner wall surface of the wellbore; and
(c) continuing to apply the radial load causing the metallic conforming material to change shape in conformance with the shape of the inner wall surface of the wellbore, thereby creating a seal between the inner wall surface of the wellbore and the sealing device.

20. The method of claim 19, wherein the metallic core material is disposed on a rib, the rib being disposed on the outer wall surface of the tubular member, and
wherein during step (c), the rib transfers the radial load to the metallic conforming material.
